(19) United States
(12) Patent Application Publication
(10) Pub. No.: US 2015/0139403 A1
(43) Pub. Date: May 21, 2015

(54) X-Ray Tube

(71) Applicants: Jan Berk, Hohenroda (DE); Jana Noack, Nurnberg (DE); Lothar Werner, Weissenohe/Dorfhaus (DE)

(72) Inventors: Jan Berk, Hohenroda (DE); Jana Noack, Nurnberg (DE); Lothar Werner, Weissenohe/Dorfhaus (DE)

(21) Appl. No.: 14/549,284

(22) Filed: Nov. 20, 2014

(30) Foreign Application Priority Data
Nov. 21, 2013 (DE) 102013223787.1

(51) Int. Cl. H01J 35/14

(52) U.S. Cl. CPC H01J 35/14
USPC 378/137

(57) ABSTRACT

An x-ray tube with a vacuum housing includes a cathode chamber with a cathode arrangement, an anode chamber with an anode arrangement, and a drift path disposed between the cathode chamber and the anode chamber. The drift path is surrounded by a magnet arrangement. The magnet arrangement is a self-supporting construction.

This application claims the benefit of DE 10 2013 223 787.1, filed on Nov. 21, 2013, which is hereby incorporated by reference in its entirety.

### BACKGROUND

The present embodiments relate to an x-ray tube.

Such an x-ray tube is known, for example, from U.S. Pat. No. 6,339,635 B1. The x-ray tube has a vacuum housing including a cathode chamber with a cathode arrangement, an anode chamber with an anode arrangement, and a drift path. The drift path is disposed between the cathode chamber and the anode chamber and is surrounded by a magnet arrangement embodied as a quadrupole.

An x-ray tube that has a magnet arrangement embodied as a double quadrupole is described in EP 2 074 642 B1 and WO 2008/155695 A1, respectively.

With the known x-ray tubes, the magnet arrangements serve to focus and to deflect the electrons created in the cathode arrangement and strike the anode as an electron beam at a focal point.

In the known cases, during the installation of the x-ray tube in each case, the magnet arrangement on the vacuum housing of the x-ray tube is aligned very precisely and fastened to the vacuum housing by installation parts (e.g., support bolts). These measures are accordingly time-consuming, as a result of the precision to be provided.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an x-ray tube with a simple construction is provided.

The x-ray tube includes a vacuum housing having a cathode chamber with a cathode arrangement, an anode chamber with an anode arrangement, and a drift path that is disposed between the cathode chamber and the anode chamber. The drift path is surrounded by a magnet arrangement. In accordance with one or more of the present embodiments, the magnet arrangement is a self-supporting construction.

As a result of the self-supporting construction of the magnet arrangement, the x-ray tube has a constructively-simple structure and thus requires less installation effort compared to the known solutions.

The fact that the magnet arrangement is a self-supporting construction provides that the magnet system does not have to be aligned and fastened to other components of the x-ray tube.

In one embodiment, a self-supporting magnet arrangement is obtained by the magnet arrangement including at least two pre-installed part shells.

In one embodiment, the at least two part shells include identical parts (e.g., the part shells; the supports embodied in each case as a magnetic yoke (core laminations) and the coil packages). This produces a constructively-simple and thus lower-cost design. Ease of installation is improved further, since additional installation parts (e.g., support bolts) are not needed.

In the exemplary embodiment, the part shells of the magnet system may, for example, additionally support the cathode arrangement and thus additionally assume a supporting function in the x-ray tube.

According to one embodiment, the magnet arrangement includes only two pre-installed half shells. The two half shells are installed from two sides around the drift path (e.g., drift tube) and screwed to themselves. The magnet arrangement is thus fastened via the two half shells to the vacuum envelope of the x-ray tube.

The magnet arrangement is suitable for accepting the widest variety of magnet arrangements. Examples of such magnet arrangements are dipole, quadrupole, double quadrupole or octopole.

### BRIEF DESCRIPTION OF THE DRAWINGS

FIG. 1 shows an exemplary half-section of an x-ray tube axial to a longitudinal axis of an x-ray tube; and

FIG. 2 shows a cross-section through the x-ray tube along line II-II in FIG. 1.

### DETAILED DESCRIPTION

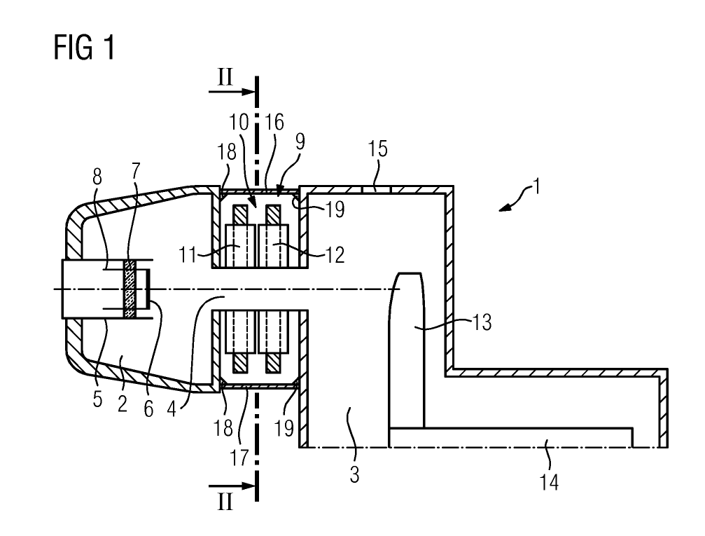

Element 1 identifies a vacuum housing for an x-ray tube depicted in FIG. 1. The vacuum housing 1 includes a cathode chamber 2, an anode chamber 3 and a drift path 4 that is disposed between the cathode chamber 2 and the anode chamber 3.

Such an x-ray tube is disposed as a part of an x-ray emitter in an emitter housing not shown in the drawing. A liquid cooling and insulation medium circulates in the emitter housing for cooling and insulating the x-ray tube.

Disposed in the cathode chamber 2 of the x-ray tube is a cathode arrangement 5 that has an emitter 6 held in an insulator 7. The cathode arrangement 5 is able to be connected via a high-voltage connection 8 to a corresponding power supply. On application of a high-voltage, the emitter 6 of the cathode arrangement 5 emits electrons. The power supply and the corresponding high-voltage cable as well as the emitted electrons are not shown in FIG. 1.

The electrons emitted by the emitter 6 of the cathode arrangement 5 are accelerated and focused in the known way in the drift path 4, which is embodied as a drift tube.

The drift path 4 is surrounded by a magnet arrangement 9, which in the exemplary embodiment shown, includes a double quadrupole 10, including a first quadrupole 11 and a second quadrupole 12. When the electrons pass through the first quadrupole 11, the electrons are initially defocused (e.g., expanded) and subsequently, when the electrons pass through the second quadrupole 12, focused to an electron beam. The electron beam leaves the drift path 4 after the electron beam has been focused and enters the anode chamber 3, in which a rotary anode 13 is disposed that is held in a torsion-proof manner on a rotor shaft 14.

The focused electron beam strikes the rotary anode 13 at a focal point and forms a focused track on the surface of the rotary anode 13. The x-ray radiation arising in the anode material exits from the vacuum housing 1 through an exit window 15.

In accordance with one or more of the present embodiments, the magnet arrangement 9 is a self-supporting construction.

In the exemplary embodiment shown, the magnet arrangement 9 includes two pre-installed half shells 16 and 17 that are installed from two sides around the drift path 4 (e.g., drift tube) and screwed to themselves. The magnet arrangement 9 is thus fastened via the two half shells 16 and 17 to the vacuum envelope 1 of the x-ray tube.

In one embodiment, the half shells 16 and 17 are supported on a circumferential collar 18 and a circumferential collar 19. The circumferential collar 18 is disposed in an area of the cathode chamber 2 on the vacuum housing 1, while the circumferential collar 19 is disposed in an area of the anode chamber 3 on the vacuum housing 1.

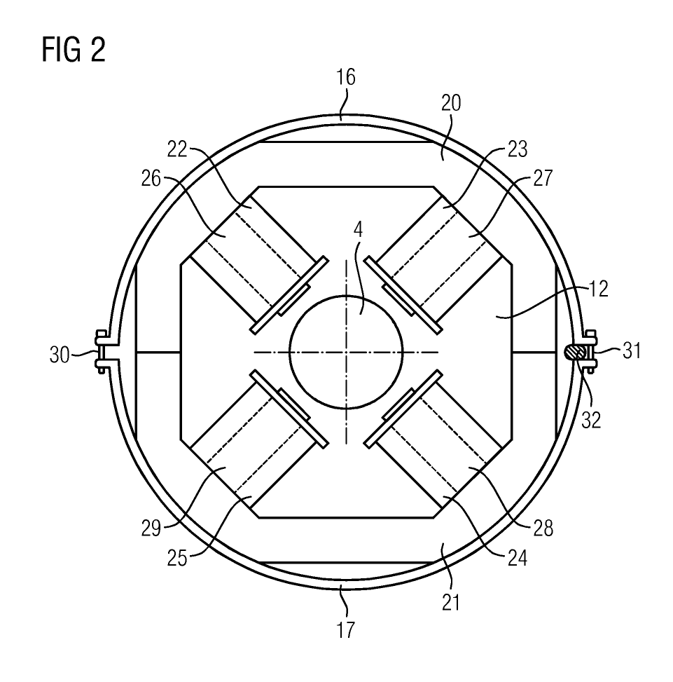

As shown in FIG. 2, the two half shells 16 and 17 at least include identical parts. This includes the half shells 16 and 17, supports 20 and 21 embodied as a magnetic yoke (e.g., core laminations) in each case, and coil packages 22 to 25. This produces a constructively-simple and thus low-cost design. The ease of installation is further improved, since additional installation parts (e.g., support bolts) are not needed.

In the exemplary embodiment depicted in FIGS. 1 and 2, the half shells 16 and 17 of the magnet arrangement 9 may, for example, additionally support the cathode chamber 2 and the cathode arrangement 5 disposed therein and thus additionally assume a supporting function in the x-ray tube.

The two quadrupoles 11 and 12 of the double quadrupole 10 are identically constructed in the exemplary embodiment shown, and each includes four identically-structured coil packages.

FIG. 2 shows the structure of the second quadrupole 12 by way of an example.

The second quadrupole 12 includes two supports 20 and 21 that together form an octagonal magnetic yoke. The support 20 has two pole projections 26 and 27 protruding radially inwards. The support 21 has two pole projections 28 and 29 protruding radially inwards. The octagonal magnetic yoke formed by the supports 21 and 22 thus includes four pole projections 26 to 29 protruding radially inwards.

The pole projections 26 to 29 are arranged evenly in relation to one another at an angle of 90°.

The cross-sectional shape of the pole projections 26 to 29 is essentially rectangular in the exemplary embodiment shown. The distance between the pole projections 26 and 28 or 27 and 29 is dimensioned such that the distance is somewhat larger than the outer diameter of the drift path 4 of the vacuum housing 1, since the supports 20 and 21 that form the magnetic yoke are disposed around the drift path 4.

The two half shells 16 and 17 are connected to one another after installation on the drift path by screw connections 30 and 31 in a non-positive fit and fixed by a torsion-proof securing element 32 that is held in the vacuum housing 1.

The present embodiments are able to be implemented for a plurality of x-ray tubes and are suitable for a plurality of x-ray systems.

Although the invention has been illustrated and described in greater detail by the exemplary embodiments, the invention is not restricted by the exemplary embodiments shown in the drawings. Other variants may be derived therefrom by the person skilled in the art without departing from designing the magnet arrangement of the x-ray tube as a self-supporting construction.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An x-ray tube with a vacuum housing, the x-ray tube comprising:
a cathode chamber with a cathode arrangement;
an anode chamber with an anode arrangement; and
a drift path that is disposed between the cathode chamber and the anode chamber,
wherein the drift path is surrounded by a magnet arrangement, the magnet arrangement being a self-supporting construction.

2. The x-ray tube of claim 1, wherein the magnet arrangement comprises at least two pre-installed part shells.

3. The x-ray tube of claim 2, wherein the magnet arrangement comprises only two pre-installed half shells.

4. The x-ray tube of claim 1, wherein the magnet arrangement contains a dipole.

5. The x-ray tube of claim 1, wherein the magnet arrangement contains a quadrupole.

6. The x-ray tube of claim 1, wherein the magnet arrangement contains a double quadrupole.

7. The x-ray tube of claim 1, wherein the magnet arrangement contains an octopole.

8. The x-ray tube of claim 1, wherein the self-supporting construction is free of bolt connection to a vacuum housing of the drift path.

9. The x-ray tube of claim 3, wherein the pre-installed half-shells are connected to each other around a vacuuming housing.

10. An x-ray tube with a vacuum housing, the x-ray tube comprising:
a cathode chamber with a cathode arrangement;
an anode chamber with an anode arrangement;
a drift path that is disposed between the cathode chamber and the anode chamber; and
a vacuum housing defining the drift path surrounded by a magnet arrangement, the magnet arrangement comprising two parts connected to each other.

11. The x-ray tube of claim 10, wherein the two parts of the magnet arrangement comprise at least two pre-installed part shells.

12. The x-ray tube of claim 11, wherein the magnet arrangement comprises only two pre-installed half shells.

13. The x-ray tube of claim 10, wherein the magnet arrangement contains a dipole.

14. The x-ray tube of claim 10, wherein the magnet arrangement contains a quadrupole.

15. The x-ray tube of claim 10, wherein the magnet arrangement contains a double quadrupole.

16. The x-ray tube of claim 10, wherein the magnet arrangement contains an octopole.

17. The x-ray tube of claim 10, wherein the magnet arrangement is free of bolt connection to the vacuum housing of the drift path.
